(19) United States
(12) Patent Application Publication
(10) Pub. No.: US 2022/0092676 A1
(43) Pub. Date: Mar. 24, 2022

(54) CLIENT SUBSCRIPTION HYDROPONIC SYSTEM AND METHOD

(71) Applicant: James Eric Parris, Hailey, ID (US)

(72) Inventor: James Eric Parris, Hailey, ID (US)

(21) Appl. No.: 17/483,778

(22) Filed: Sep. 23, 2021

Related U.S. Application Data
(60) Provisional application No. 63/204,287, filed on Sep. 24, 2020.

(51) Int. Cl. G06Q 30/06; A01G 31/02

(52) U.S. Cl. CPC G06Q 30/0633; G06Q 30/0603; A01G 31/02

(57) ABSTRACT

A client subscription hydroponic system and method is provided that includes a growth module and a hydro-farm, where the growth module has a replaceable growth media element configured for growing a living plant in a growth module nutrient solution, where the growth module is assigned to a client according to a subscription software account hosted on a remote computer. The client is provided an option to order a growth media element and a genus of a replacement plant from a hydro-farm using a subscription software mail-order purchase process. The hydro-farm and growth media element nutrient solution physical parameters are matched prior to shipping the growth media element and the replacement plant from the hydro-farm. The ordered growth media element and the replacement plant are installed to the growth module, where the subscription account is updated according to activity of the subscription activity with the remote computer program.

### CROSS-REFERENCE TO RELATED APPLICATIONS

This application claims priority from U.S. Provisional Patent Application 63/204,287 filed Sep. 24, 2020, which is incorporated herein by reference.

### FIELD OF INVENTION

The invention generally relates to hydroponically grown plants, more specifically the invention relates to a subscription-based hydroponic network system and method, where a client dedicated growth module grows plants to a subscribing customer, where the growth module is connectively integrated to a growth management system. Selectable plant genera that are hosted in interchangeable growth packets in the growth module are purchased through a subscription account and delivered to the client for installation to the growth module, while the plant health and growth parameters are managed and controlled for the client using a remote and artificial intelligence computer program hosted on a remote computer.

### BACKGROUND OF THE INVENTION

Threats to world-wide food security are increasing by drought, contamination, safe access, efficient yield and reduced nutritional content. In food safety alone, the CDC estimates salmonella bacteria causes about 1.35 million infections, 26,500 hospitalizations and 420 deaths in the United States every year. Whereas with food supply chain disruption in the US for example, the COVID-19 pandemic outbreak caused consumer panic-buying, resulting in food shortages nationwide. Further, consolidation of supplies, and genetically modified foods (GMO) have resulted in increasingly nutrition-free plant foods to consumers.

What is needed is a system and method for enabling access to safe and nutritious food from home, where the food is grown and harvested in coordination with hydroponics, artificial intelligence, and a network of hydroponic growth farms.

### SUMMARY OF THE INVENTION

To address the needs in the art a client subscription hydroponic system and method is provided that includes a growth module and a hydro-farm, where the growth module has a growth media element configured for growing a living plant in a growth module nutrient solution, where the growth media element is a replaceable growth media element, where the growth module is assigned to a client according to a subscription software account hosted on a remote computer, where the client is provided an option to order a growth media element and a genus of a replacement plant from a hydro-farm using a subscription software mail-order purchase process hosted on the remote computer, where the hydro-farm nutrient solution physical parameters match the growth module nutrient solution physical parameters prior to shipping the growth media element and the replacement plant from the hydro-farm, where the ordered growth media element and the replacement plant are installed to the growth module, where the subscription account is updated according to activity of the subscription activity with the remote computer program.

In one aspect of the invention, the remote computer is programmed to automatically alter growth conditions of the growth module by operating a system of growth module sensors, growth module computers, and growth module controllers, where physical parameters of the growth module and physical parameters of the growth module nutrient solution are optimized for plant growth, where the growth module communicates physical parameter data of the growth module nutrient solution to the remote computer, where the growth module nutrient solution physical parameter data is selected from the group consisting of pH values, electrical conductivity, and temperature, where the remote computer communicates the growth module solution data to a computer configured to control physical parameters of the hydro-farm nutrient solution.

In another aspect of the invention, the remote computer is programmed to automatically alter growth conditions of the hydro-farm by operating a system of hydro-farm sensors, hydro-farm computers, and hydro-farm controllers configured to optimize physical parameters of the hydro-farm and physical parameters of the hydro-farm nutrient solution that are optimized for plant growth, where a hydro-farm computer communicates hydro-farm nutrient solution physical data to the remote computer, where the hydro-farm nutrient solution data is selected from the group consisting of pH values, electrical conductivity, and temperature, where the remote computer communicates the hydro-farm solution physical data to a computer configured to control physical parameters of the growth module nutrient solution.

The system and method according to claim 1, wherein a growth module and said subscription account comprises a fee-based growth module usage account selected from the group consisting of a month-to-month rental agreement, a lease agreement, a rent-to-own agreement, a mail-order minimum plant purchase process agreement, and a purchase agreement.

According to a further aspect of the invention, the growth module computer and the remote computer exchange data that includes growth module structure data, nutrient solution data, growth module environment data, and plant growth data.

In yet another aspect of the invention, the subscription account includes a login customer portal hosted on the remote computer, where the customer portal is configured to facilitate a customer action that includes mail-order scheduling, mail-order purchases, plant rentals, webcam viewing, tracking or delivery scheduling, growth system maintenance scheduling, plant care scheduling, and financial transactions.

According to one aspect of the invention, the growth module includes a plurality of the growth modules distributed across a geographic region, where the growth modules are dedicated to a plurality of clients.

In a further aspect of the invention, the growth module has a structure that includes a customer assembled structure, a pre-assembled structure, a customized structure, a fixed structure, a movable structure, a built-in structure, or a modular structure.

In another aspect of the invention, a growth system is provided that includes a hydroponic system, an aeroponic system, a deep-water culture system, a wick system, a drip system, an ebb and flow system, or an aquaponic system.

According to a further aspect of the invention, the growth module controller is configured to control growth appliances that include a light, a fan, a heater, a cooler, a humidifier, a nutrient solution thermal regulator, a nutrient conduit, a nutrient reservoir, a nutrient solution pump, a nutrient solution timer, a light timer, a fan timer, a heater timer, a cooler timer, a camera, an internet connection, a nutrient solution sensor, a light sensor, a temperature sensor, an oxygen sensor, or a humidity sensor. Here, the light is can include a tubular fluorescent light, a high-intensity discharge light, a light emitting diode light, a compact fluorescent light, a double-ended light, or a Sulphur plasma light. In another aspect the nutrient conduit can include a drip conduit, an ebb and flow conduit, a deep-water culture conduit, a wick conduit, an aeroponic conduit, nutrient film conduit, or an aquaponic conduit. In another aspect, the nutrient conduit connects the nutrient reservoir to the growth medium, where the nutrient conduit is configured to recirculate a nutrient solution between the growth medium and the nutrient reservoir, wherein the plant receives the nutrient solution through the growth medium.

According to another aspect of the invention, the growth module controllers control growth parameters that include air flow, air temperature, air circulation velocity, air circulation scheduling, light brightness, light spectrum, light temperature, light duration, nutrient solution pH, nutrient solution electrical conductivity, nutrient solution temperature, nutrient solution conductivity, nutrient solution recirculation flux, a duration of said nutrient solution recirculation flux, nutrient solution volume levels, nutrient solution pump scheduling, ambient air humidity, ambient air CO₂ levels, ambient air O₂ levels, heating and cooling scheduling, or webcam monitoring.

In yet another aspect of the invention, the growth media that includes rockwool, clay aggregate, clay pellets, coco fiber, coco chips, coco coir, phenolic foam, perlite, rock, glass beads, gravel, phenolic foam, sand, sawdust, root cubes, soilless mixtures, hypnaceous moss, sphagnum moss, sawdust, barks, rice hulls, manures, corn cobs, straw, peanut shells, pecan shells, sand, vermiculite, calcined clays, pumice, cinders and pea-gravel, polystyrene flakes, or urea formaldehyde foams.

According to one aspect of the invention, the replaceable growth media hosts a plant that can include a a seed-plant, a sprouted plant, a 1 to 2-week old plant, a 2 to 4-week old plant, a 4 to 6-week old plant, a 6 to 8-week old plant, OR a plant older than 8-weeks.

In a further aspect of the invention, the replaceable growth media includes a root mass, where the replaceable growth media and the root mass are formed in a standardized shape, where the standardized shape is configured to interchangeably fit to a nutrient conduit of the growth module, where the replaceable growth media and the root mass include a modular and interchangeable growth medium and root mass hosting a live the plant.

In yet another aspect of the invention, the replaceable growth media includes a plant having a spliced root mass, where the spliced root mass is a segment of a network of root masses in a plurality of hydro-farm plants. Here, the spliced root mass is covered by a plant cover plate, where the plant cover plate includes an opening disposed to receive said plant growing therethrough, where the plant cover plate includes a geometric shape that is configured to fitably interchange between said hydro-farm and said growth module.

### BRIEF DESCRIPTION OF THE DRAWINGS

FIG. 1 shows a schematic drawing of a growth module, according to one embodiment of the invention.

FIGS. 2-3 show flow diagrams of a client and remote computer relationship, according to embodiments of the invention.

FIG. 4 shows a flow diagram of the process of a live plant in a growth media moving from the hydro-farm to the client growth module, according to one embodiment of the invention.

FIGS. 5A-5B show a root mass cutter segmenting the root mass of an individual plant (FIG. 5A), and a segmented root mass incorporated to a shipping container (FIG. 5B), according to one embodiment of the invention.

FIGS. 6A-6B show a series of porous sleeves for root mass growth, and a root mass cutter disposed for segmenting the root mass of an individual plant (FIG. 6A), and a porous sleeve for a segmented root mass (FIG. 6B), according to one embodiment of the invention.

### DETAILED DESCRIPTION

To address the needs in the art, the current invention is directed a subscription-based hydroponic system for facilitating both inexperienced and experienced users to grow their own safe-produce in the security of their own home or establishment. According to one aspect of the current invention, a client subscribes to a mail-order plant purchase agreement, whereby the subscriber is provided a self-sustaining hydroponic unit, or growth module, that is configured to grow various vegetables and fruits, as selected by the subscriber. Here the client is able to login into their personalized account and order from a menu, living plants that are delivered by mail, where the client's account is appropriately billed. The mail-ordered plants are held in a growth media and nutrient solution and are readily installable by the client to a growth conduit of the growth module, or the selected plants are installed by an authorized plant-care technician. Each growth module unit is in communication with a remote, central computer that facilitates the growth and health of the client's plants using a software program, such as artificial intelligence, that analyzes data from a plurality of sensors on the growth module, to operate a system of actuators and controllers in the growth module that are directed to optimizing the module's growth conditions. In one aspect, the client receives routine deliveries of nutrient solutions and plant-care products, and optionally scheduled plant-care technician visits, which are automatically billed to the client account according to the subscription agreement. The growth cycle of all the plants is tracked and forecast, where the forecast provides an output of an optimum harvest date for each plant.

The client's subscription-based growth module communicates with the remote computer using the internet. The growth module includes replaceable growth media elements growing the plants, where the client uses the subscription mail-order process hosted on the remote computer to purchase a quantity of the growth media elements and a genus of plants that have already been growing in a remote hydro-farm. The growth module of the client communicates the nutrient solution data to the remote computer, where the nutrient solution data includes pH values, electrical conductivity, and temperature. Optionally, the client can order a plant having specific nutrient solution parameters. The remote computer communicates the client's growth module solution data with a hydro-farm operator, where the replacement growth media and living plant from the hydro-farm has a matching nutrient solution stoichiometry to the nutrient solution of the client's growth module prior to shipping to the client. Here, the client nutrient solution data and the hydro-farm nutrient solution data can match according to the variant ranges that include 0-1%, 1-5%, 5-10%, 10-15%, 15-20%, 20-25%, 25-30%, 30-35%, 40-45%, 45-50%, or above 50%. Once the growth media and plants are installed to media ports of the growth module conduit, the remote computer receives and uses growth module data to automatically alter growth conditions for the plants by operating a system of growth module sensors, computers, and controllers for optimize the growth parameters of the plants. The subscription account is updated according to the activity of the subscription mail-order process and of the altered growth conditions.

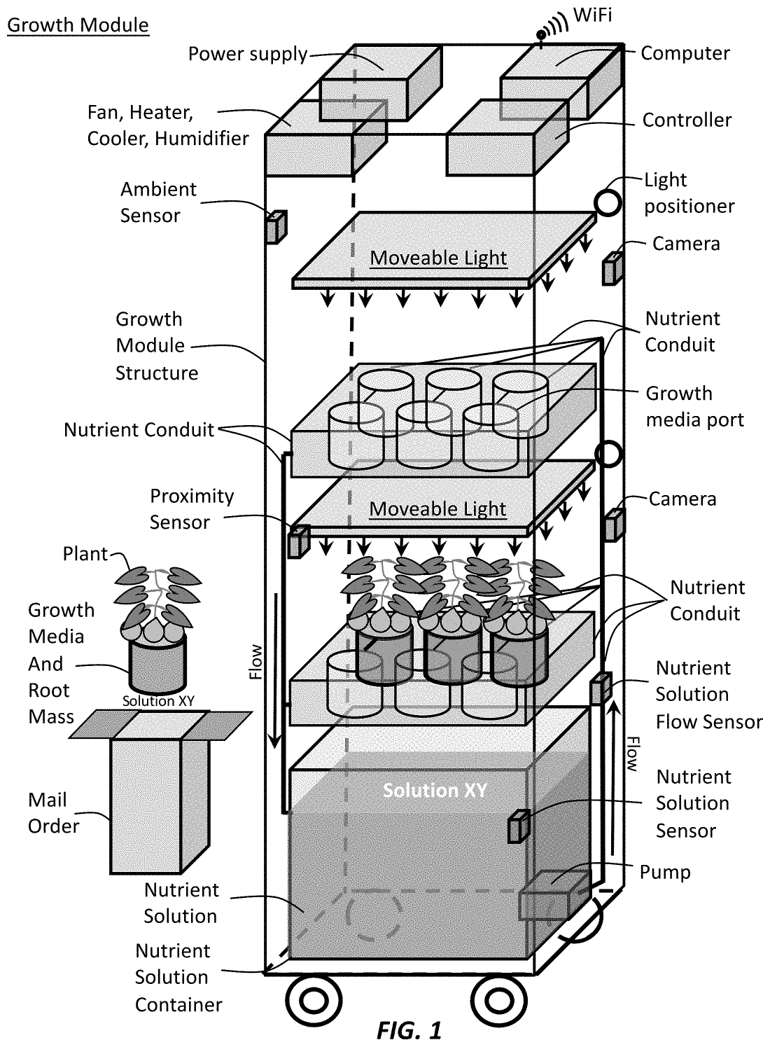

According to different embodiments, invention includes a variety of growth modules that range in size, capacity, aesthetics, complexity, capabilities, and price. Turning now to the figures, FIG. 1 shows a growth module housing an exemplary hydroponic system, according to one embodiment of the invention. In other embodiments, the growth module is a custom-built, or a standardized module that can be movable, stationary, or built-in. As shown in FIG. 1, the growth module includes a structure for housing a processor, or computer, a power supply, a controller, a timer, a fan, a heater, a cooler, a humidifier, a nutrient solution container, growth media ports, where the growth media ports are connected to the nutrient solution container using a nutrient conduit. Further, the nutrient solution is recirculated through the conduit using a pump that can be configured to add oxygen to the nutrient solution, and filter debris from the solution. According to the current invention, the growth module is configured to house different hydroponic systems that include an aeroponic system, a deep-water culture system, a wick system, a drip system, an ebb and flow system, or an aquaponic system. In other embodiments, the nutrient conduit includes a drip conduit, an ebb and flow conduit, a deep-water culture conduit, a wick conduit, an aeroponic conduit, nutrient film conduit, or an aquaponic conduit. The structure additionally includes lighting, cameras, and a system of sensors, where the sensors monitor growth conditions and output data including temperature, humidity, nutrient solution flow rate, nutrient solution pH and electrical conductivity, while the camera outputs plant growth visual parameters.

According to other embodiments of the current invention, the growth module controller is configured to control growth appliances for managing growth aspects that include lighting, air flow, heating/cooling, humidity, timing, pump flux, and nutrient solution parameters. The lighting aspects include color, temperature, brightness, duration, timing, and separation between the plant and light, which is controlled by a positioning motor in communication with the controller. According to embodiments of the invention, the light can include a tubular fluorescent light, a high-intensity discharge light, a light emitting diode light, a compact fluorescent light, a double-ended light, or a Sulphur plasma light. Ambient air conditions and flow velocity are controlled using a timer in coordination with a variable-rate fan, a heater/cooler, and a humidifier. The nutrient conduit connects the nutrient reservoir to the growth medium, where the nutrient conduit is configured to recirculate the nutrient solution between the growth medium and the nutrient reservoir, whereas the plant receives the nutrient solution through the growth medium. The nutrient solution parameters include solution temperature, flow rates, duration, pH balance, electrical conductivity, oxygen content, and reservoir level. The controller is in communication with a system of sensors configured to output data such as webcam monitoring, light intensity, light position, air temperature, humidity and flow rate.

The replaceable growth media is formed in a shape that is standardized, where the standardized shape is configured to interchangeably fit to a growth media and root mass port in the nutrient conduit of the growth module, where the replaceable growth media and root mass is a modular and interchangeable combination hosting the live plant. In one embodiment, the root mass is spliced of cut to the standardized shape. According to the current invention, the growth media includes rockwool, clay aggregate, clay pellets, coco fiber, coco chips, coco coir, phenolic foam, perlite, rock, glass beads, gravel, phenolic foam, sand, sawdust, root cubes, soilless mixtures, hypnaceous moss, sphagnum moss, sawdust, barks, rice hulls, manures, corn cobs, straw, peanut shells, pecan shells, sand, vermiculite, calcined clays, pumice, cinders and pea-gravel, polystyrene flakes, or urea formaldehyde foams.

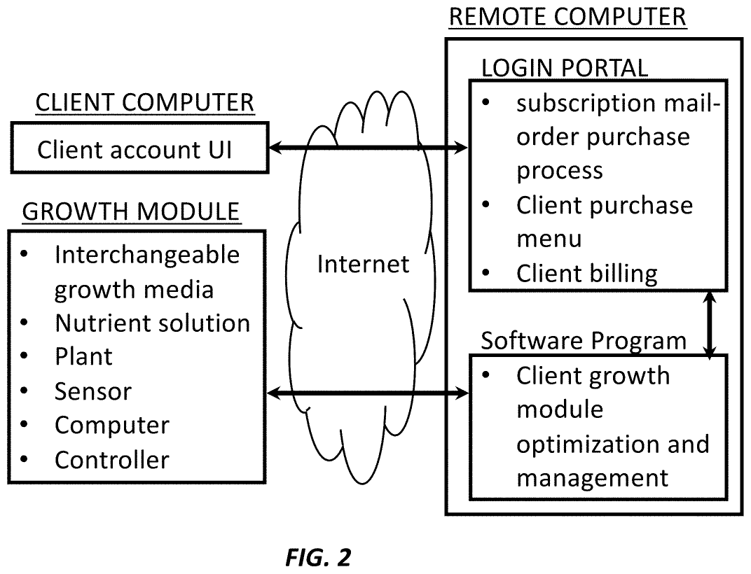

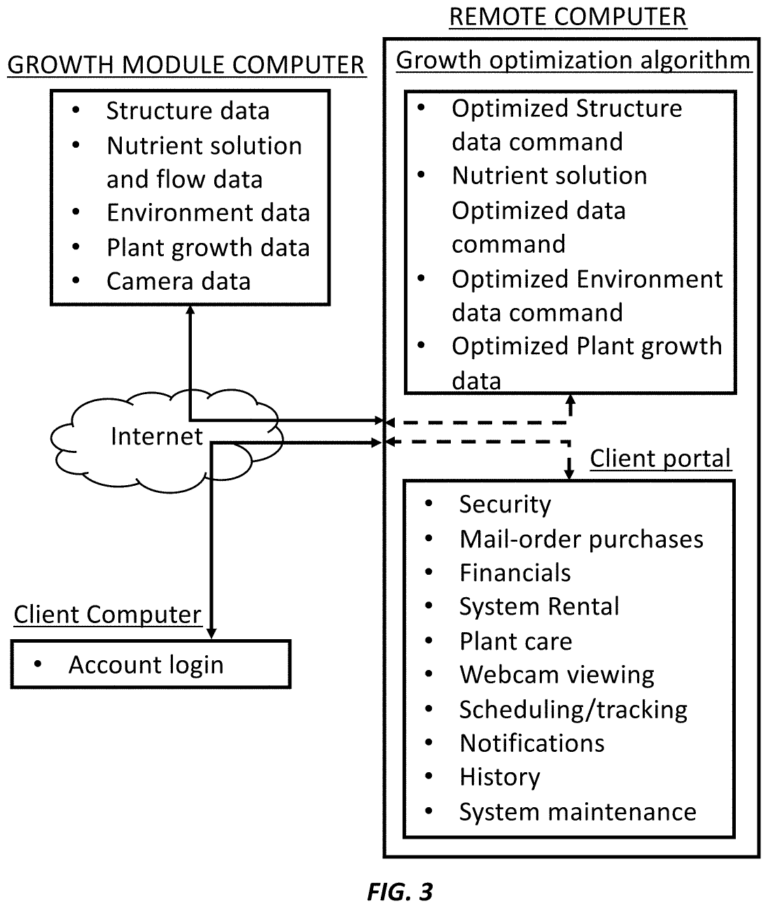

In another aspect of the invention, the remote computer operates a database that is programmed to manage client care options such as purchases, scheduling, shipping, billing, communications, or harvest tracking. FIGS. 2-3 show a flow diagrams of the relationship between the client and remote computer using the login portal. Here, the remote computer is configured to enable client login access using the internet, where the login portal enables two-way communication between the remote computer and the client to arrange for on-site service, scheduling for pickup and delivery of purchased items, account monitoring, and notifications.

According to the invention, the client selects a plant-care option from a menu on the subscription account that includes selecting an on-site plant-care technician visit for performing a service that includes plant harvesting, plant trimming, plant health inspection, growth media installation, growth media replacement, growth module maintenance, or client support. Other service aspects include system installation, setup and maintenance, nutrient solution care/maintenance, and growth module staging, where the growth module staging is useful, for example, when a client is returning from extended travel and requests a mature home farm for harvesting upon arrival. Regarding the on-site plant harvesting, harvesting by the plant-care technician is applicable for when the clients are away from their growth module and unable to harvest their produce to maintain the health and vitality of their growth module produce. In yet another aspect of the invention, the growth module includes a plurality of the growth modules distributed across a geographic region, where the growth modules are dedicated to a plurality of the clients. Here, the geographic region includes an urban region, a rural region, a resort region, a gated community region, an interstate region, an intrastate region, or an international region. In one aspect, the database computer algorithm is configured to optimize the on-site plant harvesting by the plant-care technician across a plurality of client growth modules. Here, the harvested produce is sold or distributed to restaurants, markets, or foodbanks.

FIG. 3 further shows how the growth module computer and the remote computer are configured to exchange data that includes growth module structure data, nutrient solution data, growth module environment data, and plant growth data. Additionally, FIG. 3 shows the login customer portal of the subscription account hosted on the remote computer, where the customer portal is configured to facilitate customer instructions that include mail-order scheduling, mail-order purchases, plant and growth module rentals, webcam viewing, order tracking, growth system maintenance scheduling, plant care scheduling, or financial transactions.

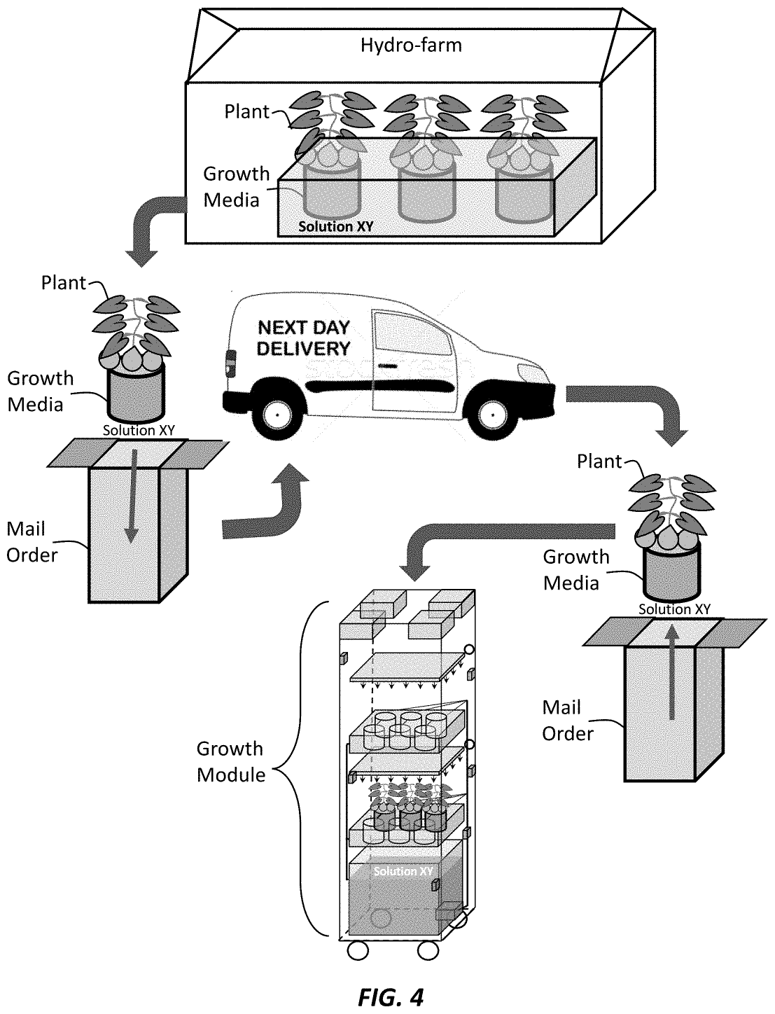

In yet another aspect of the invention, a fee-based growth module usage account is established for the client that includes a month-to-month rental agreement, a lease agreement, a rent-to-own agreement, a mail-order minimum plant purchase process agreement, or a purchase agreement. In one aspect, the client subscription account fee is credited according to activity levels of the mail-order purchase process. In another aspect, the client may select a standard, basic growth module for a low price, or even free of charge. Here the client agrees to a contract for purchasing a minimum number of plants, a minimum quantity of nutrition solution, a minimum amount of plant care products, and a minimum number of plant-care technician visits on a recurring basis. According to other aspects of the invention, the growth module structure includes a customer assembled structure, a pre-assembled structure, a customized structure, a fixed structure, a movable structure, a built-in structure, or a modular structure. Once the growth module structure is fully installed or setup, and the growth module is in communication with the remote computer, the client receives their selected plants in the growth media for installation to the growth module. FIG. 4 shows a flow diagram of the process of a live plant in a growth media moving from a remote hydroponic farm (hydro-farm) to the client growth module, according to one embodiment of the invention. In one embodiment, the plant-care technician provides the growth module assembly, installation, remote computer connection, and growth media with living plant installation, where the client account is billed accordingly.

To support the needed living plant product inventory, the invention includes one or more remote hydro-farms hosting plants that are listed on the online menu of the plant selection from which the client orders their plants. The hydro-farm maintains a maturity range of the plants so as to accommodate varying demand loads. The hydro-farm plants are simultaneously harvested for commercial produce sales, for example to supermarkets or restaurants, as plant care is implemented for the mature plant inventory. Each of the hydroponic farm plants are housed in the replaceable growth media that the growth module uses. According to embodiments of the invention, the living plant in the replaceable growth media includes a seed-plant, a sprouted plant, a 1 to 2-week old plant, a 2 to 4-week old plant, a 4 to 6-week old plant, a 6 to 8-week old plant, or a plant older than 8-weeks. In one aspect, the mature inventory is hosted in a growth module (mature growth module) that is ready for purchase, lease, or rent by a client as a site-ready system. Here, the client pre-orders one or more mature growth modules using their login account to the database portal, detailing the quantity of growth modules, and the genera of mature plants for use and consumption. The client identifies the start-date and end-date, where the mature growth module is delivered and installed on the start-date, and picked up on the end-date. In one aspect, the client can purchase a complete site-ready system.

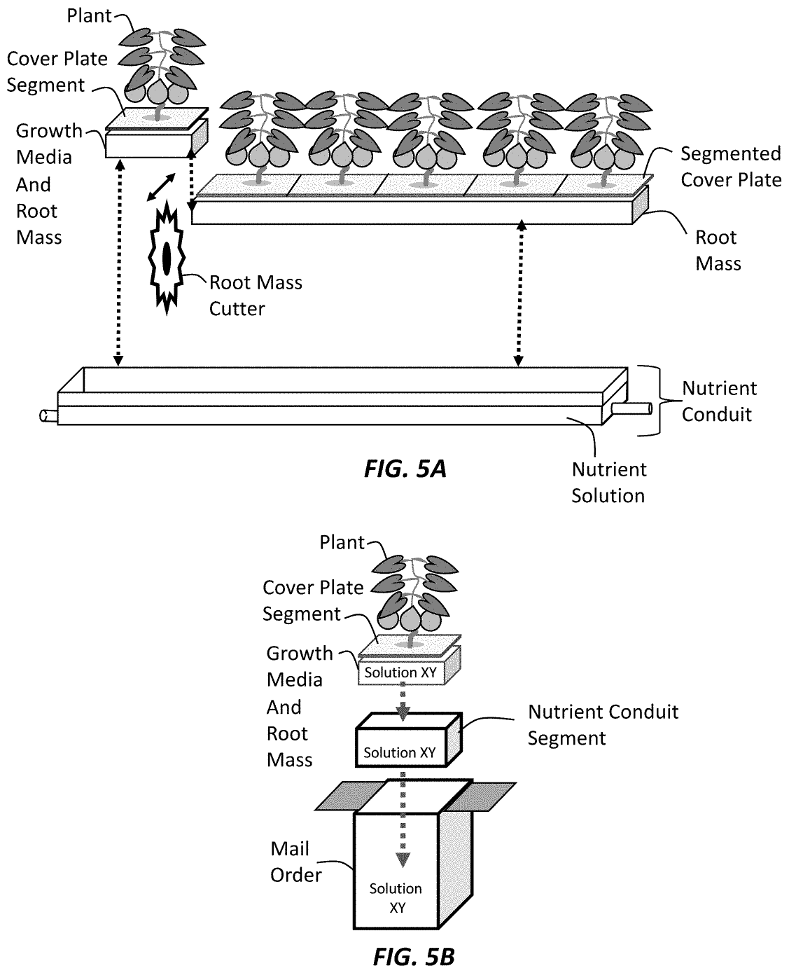

FIGS. 5A-5B show schematic drawings the shape of the growth media and root mass as they are formed by cutting the root mass within a nutrient conduit. As shown in FIG. 5A, the root mass cutter slices one plant's root mass from a larger root mass formed by a series of growing plants. Further shown is a cover plate segment that is configured to fitably index between a hydro-farm nutrient conduit, and a client's growth module nutrient conduit. FIG. 5B shows a segmented root mass and growth medium having a cover plate fitting to a nutrient conduit segment that is in coordination with a shipping container. The nutrient solution XY is an index-matched nutrient solution between the physical parameters of the client's growth module and the hydro-farm nutrient solutions, respectively.

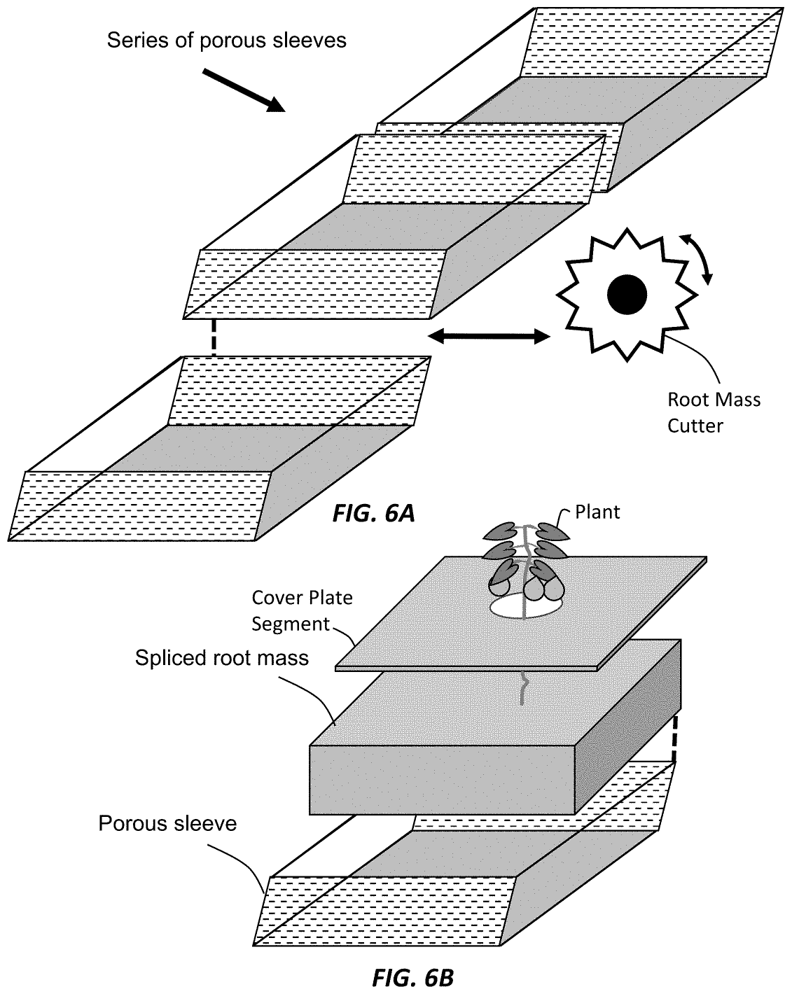

FIGS. 6A-6B show another embodiment of the invention that includes a porous sleeve disposed for housing a growth media and root mass in a predefined shape. As shown in FIG. 6A, the root mass is segmented using a cutting tool that is configured to cut between two adjacent porous sleeves, whereby segmenting the root mass that grows from one porous sleeve to the other. FIG. 6B shows an exploded perspective view of a segmented root mass within a porous sleeve, that are covered with a segmented cover plate. According to the current invention, the cover plate can incorporate clips, fittings, slots, posts, threads, etc. to accommodate the indexing between the hydro-farm nutrient conduit and the client's growth module nutrient conduit.

The present invention has now been described in accordance with several exemplary embodiments, which are intended to be illustrative in all aspects, rather than restrictive. Thus, the present invention is capable of many variations in detailed implementation, which may be derived from the description contained herein by a person of ordinary skill in the art. All such variations are considered to be within the scope and spirit of the present invention as defined by the following claims and their legal equivalents.

What is claimed:

1) A client subscription hydroponic system and method comprising a growth module and a hydro-farm, wherein said growth module comprises a growth media element configured for growing a living plant in a growth module nutrient solution, wherein said growth media element comprises a replaceable growth media element, wherein said growth module is assigned to a client according to a subscription software account hosted on a remote computer, wherein said client is provided an option to order a growth media element and a genus of a replacement plant from a hydro-farm using a subscription software mail-order purchase process hosted on said remote computer, wherein said hydro-farm nutrient solution physical parameters match said growth module nutrient solution physical parameters prior to shipping said growth media element and said replacement plant from said hydro-farm, wherein said ordered growth media element and said replacement plant are installed to said growth module, wherein said subscription account is updated according to activity of said subscription activity with said remote computer program.

2) The system and method according to claim 1, wherein said remote computer is programmed to automatically alter growth conditions of said growth module by operating a system of growth module sensors, growth module computers, and growth module controllers, wherein physical parameters of said growth module and physical parameters of said growth module nutrient solution are optimized for plant growth, wherein said growth module communicates physical parameter data of said growth module nutrient solution to said remote computer, wherein said growth module nutrient solution physical parameter data is selected from the group consisting of pH values, electrical conductivity, and temperature, wherein said remote computer communicates said growth module solution data to a computer configured to control physical parameters of said hydro-farm nutrient solution.

3) The system and method according to claim 1, wherein said remote computer is programmed to automatically alter growth conditions of said hydro-farm by operating a system of hydro-farm sensors, hydro-farm computers, and hydro-farm controllers configured to optimize physical parameters of said hydro-farm and physical parameters of said hydro-farm nutrient solution that are optimized for plant growth, wherein a hydro-farm computer communicates hydro-farm nutrient solution physical data to said remote computer, wherein said hydro-farm nutrient solution data is selected from the group consisting of pH values, electrical conductivity, and temperature, wherein said remote computer communicates said hydro-farm solution physical data to a computer configured to control physical parameters of said growth module nutrient solution.

4) The system and method according to claim 1, wherein a growth module and said subscription account comprises a fee-based growth module usage account selected from the group consisting of a month-to-month rental agreement, a lease agreement, a rent-to-own agreement, a mail-order minimum plant purchase process agreement, and a purchase agreement.

5) The system and method according to claim 1, wherein said growth module computer and said remote computer exchange data selected from the group consisting of growth module structure data, nutrient solution data, growth module environment data, and plant growth data.

6) The system and method according to claim 1, wherein said subscription account comprises a login customer portal hosted on said remote computer, wherein said customer portal is configured to facilitate a customer action selected form the group consisting of mail-order scheduling, said mail-order purchases, plant rentals, webcam viewing, tracking or delivery scheduling, growth system maintenance scheduling, plant care scheduling, and financial transactions.

7) The system and method according to claim 1, wherein said growth module comprises a plurality of said growth modules distributed across a geographic region, wherein said growth modules are dedicated to a plurality of said clients.

8) The system and method according to claim 1, wherein said growth module comprises a structure selected from the group consisting of a customer assembled structure, a pre-assembled structure, a customized structure, a fixed structure, a movable structure, a built-in structure, and a modular structure.

9) The system and method according to claim 1, wherein said growth module comprises a growth system selected from the group consisting of a hydroponic system, an aeroponic system, a deep-water culture system, a wick system, a drip system, an ebb and flow system, and an aquaponic system.

10) The system and method according to claim 1, wherein said growth module controller is configured to control growth appliances selected from the group consisting of a light, a fan, a heater, a cooler, a humidifier, a nutrient solution thermal regulator, a nutrient conduit, a nutrient reservoir, a nutrient solution pump, a nutrient solution timer, a light timer, a fan timer, a heater timer, a cooler timer, a camera, an internet connection, a nutrient solution sensor, a light sensor, a temperature sensor, an oxygen sensor, and a humidity sensor.

11) The system and method according to claim 10, wherein said light is selected from the group consisting of a tubular fluorescent light, a high-intensity discharge light, a light emitting diode light, a compact fluorescent light, a double-ended light, and a Sulphur plasma light.

12) The system and method according to claim 10, wherein said nutrient conduit is selected from the group consisting of a drip conduit, an ebb and flow conduit, a deep-water culture conduit, a wick conduit, an aeroponic conduit, nutrient film conduit, and an aquaponic conduit.

13) The system and method according to claim 10, wherein said nutrient conduit connects said nutrient reservoir to said growth medium, wherein said nutrient conduit is configured to recirculate a nutrient solution between said growth medium and said nutrient reservoir, wherein said plant receives said nutrient solution through said growth medium.

14) The system and method according to claim 1, wherein said growth module controllers control growth parameters selected from the group consisting of air flow, air temperature, air circulation velocity, air circulation scheduling, light brightness, light spectrum, light temperature, light duration, nutrient solution pH, nutrient solution electrical conductivity, nutrient solution temperature, nutrient solution conductivity, nutrient solution recirculation flux, a duration of said nutrient solution recirculation flux, nutrient solution volume levels, nutrient solution pump scheduling, ambient air humidity, ambient air CO₂ levels, ambient air O₂ levels, heating and cooling scheduling, and webcam monitoring.

15) The system and method according to claim 1, wherein said growth media is selected from the group consisting of rockwool, clay aggregate, clay pellets, coco fiber, coco chips, coco coir, phenolic foam, perlite, rock, glass beads, gravel, phenolic foam, sand, sawdust, root cubes, soilless mixtures, hypnaceous moss, sphagnum moss, sawdust, barks, rice hulls, manures, corn cobs, straw, peanut shells, pecan shells, sand, vermiculite, calcined clays, pumice, cinders and pea-gravel, polystyrene flakes, and urea formaldehyde foams.

16) The system and method according to claim 1, wherein said replaceable growth media comprises a plant selected from the group consisting of a seed-plant, a sprouted plant, a 1 to 2-week old plant, a 2 to 4-week old plant, a 4 to 6-week old plant, a 6 to 8-week old plant, and a plant older than 8-weeks.

17) The system and method according to claim 1, wherein said replaceable growth media comprises a root mass, wherein said replaceable growth media and said root mass are formed in a standardized shape, wherein said standardized shape is configured to interchangeably fit to a nutrient conduit of said growth module, wherein said replaceable growth media and said root mass comprise a modular and interchangeable growth medium and root mass hosting a live said plant.

18) The system and method according to claim 1, wherein said replaceable growth media comprises a plant having a spliced root mass, wherein said spliced root mass is a segment of a network of root masses in a plurality of hydro-farm plants.

19) The system and method according to claim 18, wherein said spliced root mass is covered by a plant cover plate, wherein said plant cover plate comprises an opening disposed to receive said plant growing therethrough, wherein said plant cover plate comprises a geometric shape that is configured to fitably interchange between said hydro-farm and said growth module.
